(19) United States
(12) Patent Application Publication
(10) Pub. No.: US 2006/0142991 A1
(43) Pub. Date: Jun. 29, 2006

(54) Remote USB network device control

(76) Inventors: Imtiaz Sajwani, Chandler, AZ (US); Dzung Tran, Beaverton, OR (US); Shailendra Sinha, Hillsboro, OR (US)

Correspondence Address: Buckley, Maschoff & Talwalkar LLC, Attorneys for INTEL Corporation, Five Elm Street, New Canaan, CT, 06840, US

(21) Appl. No.: 11/025,116

(22) Filed: Dec. 29, 2004

(51) Int. Cl. G06F 9/455

(52) U.S. Cl. 703/25

(57) ABSTRACT

According to some embodiments, remote USB network device control is provided. In some embodiments, systems and methods may include identifying an input device and emulating the input device as a universal serial bus device on a universal serial bus host. The systems and methods may further include determining if mapping information is defined for the input device, wherein the mapping information is to associate an output of the input device with at least one network device coupled to the universal serial bus host.

### BACKGROUND

Networks, such as home networks, are increasing in complexity and often include increasing numbers and types of connected devices. These network devices often communicate via various protocols and standards and may be interconnected utilizing different types or configurations of cables, connectors, ports, wires, or other devices. In some cases, a user may be required to use multiple interfaces (e.g., an interface for each network device) to interact with the various network devices connected to the network. Utilizing multiple interfaces to interact with and/or control network devices may not be desirable, particularly when one or more of the interfaces are situated in different locations (e.g., different rooms and/or different floors of a house).

### BRIEF DESCRIPTION OF THE DRAWINGS

FIG. 1 is a block diagram of a system according to some embodiments.

FIG. 2 is a block diagram of a system according to some embodiments.

FIG. 3 is a flow diagram of a method according to some embodiments.

FIG. 4 is a block diagram of a system according to some embodiments.

FIG. 5 is a flow diagram of a method according to some embodiments.

FIG. 6 is a block diagram of a system according to some embodiments.

FIG. 7 is a block diagram of a system according to some embodiments.

### DETAILED DESCRIPTION

Some embodiments herein are associated with “information” or “data”. As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known.

In addition, some embodiments described herein are associated with “information indicative of” or “indicia” of information associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information.

Some embodiments described herein are associated with a “network device”. As used herein, the phrase “network device” may refer to any device that can communicate via a network. Examples of network devices include a Personal Computer (PC), a workstation, a server, a printer, a scanner, a facsimile machine, a copier, a Personal Digital Assistant (PDA), a storage device (e.g., a disk drive), a hub, a router, a switch, and a communication device (e.g., a modem, a wireless phone, etc.). In some embodiments, network devices may include, but are not limited to, cameras, sensors (e.g., security sensors), and/or appliances (e.g., “smart” appliances). Network devices may comprise one or more network components, such as a Static Random Access Memory (SRAM) device or module, a network processor, and a network communication path, connection, port, or cable.

In addition, some embodiments are associated with a “network” or a “communication network”. As used herein, the terms “network” and “communication network” may be associated with the transmission of messages, packets, signals, and/or other forms of information between and/or within one or more network and/or user devices. By way of example, a network may be configured to operate in accordance with the Fast Ethernet LAN transmission standard 802.3-2002® published by the Institute of Electrical and Electronics Engineers (IEEE).

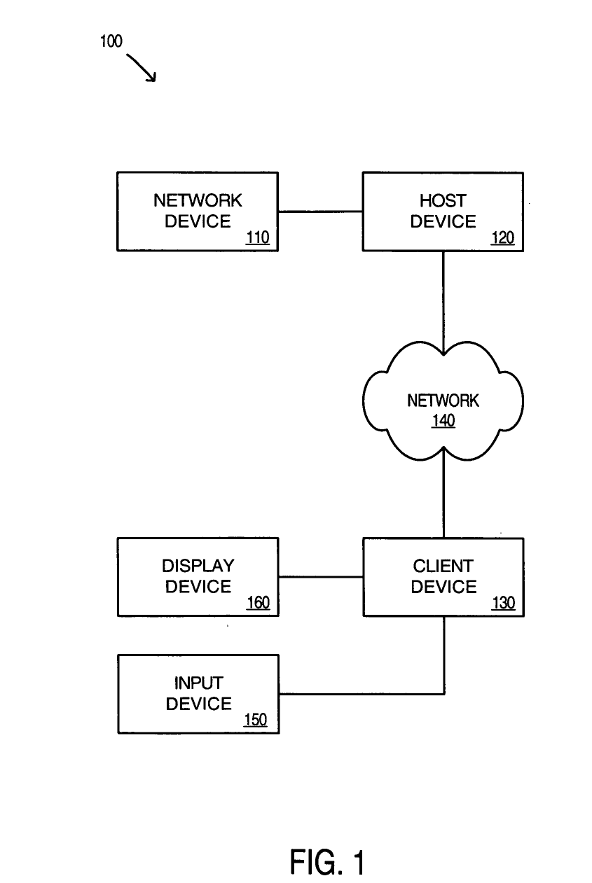

Referring first to FIG. 1, a block diagram of a system 100 according to some embodiments is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may comprise, for example, a network device 110, a host device 120, a client device 130, a network 140, an input device 150, and/or a display device 160. Any of the components 110, 120, 130, 150, 160 of the system 100 may be coupled and/or otherwise may be in communication via the network 140. In some embodiments, the network device 110 may be in communication with the host device 120 and/or either or both of the input device 150 and the display device 160 may be in communication with the client device 130. According to some embodiments, the client device 130 may be in communication with the host device 120 via the network 140.

The network 140 may be or include any quantity, configuration, and/or type of network that is or becomes known or practicable. In some embodiments, the network 140 may be a wired and/or wireless IP network. Any of the components 110, 120, 130, 150, 160 of the system 100 may, according to some embodiments, include, be included within, and/or may otherwise be associated with a computing, electronics, and/or mobile electronics device such as a PC, a notebook computer, a PDA, and/or a wireless telephone or other device. Any of the components 110, 120, 130, 150, 160 may also or alternatively be configured to operate in accordance with the Universal Serial Bus (USB) interface standard as described in the USB Specification Revision 2.0 (2000).

In some embodiments, the network device 110 may be controlled by the input device 150 (and/or a user thereof) via the host device 120 and the client device 130 by using the host device 120 as a USB interface (e.g., USB-bridging). In some embodiments, the host device 120 may provide remote USB-bridging. As an example, the network device 110 may be situated in a first location, such as on the second floor of a user's home. The user, according to some embodiments, may be utilizing the input device 150 and/or the display device 160 at another location, such as in a living room on the first floor of the user's home. In some embodiments, the user may desire to control and/or otherwise interact with the network device 110 without leaving the living room and/or without discontinuing use of the input device 150 and/or the display device 160.

The network device 110 may, for example, typically only be capable of being controlled and/or interfaced with either directly (e.g., by pushing a button on the network device 110 and/or be utilizing a remote control to send commands directly to the network device 110) and/or via the host device 120. The host device 120 may, according to some embodiments, be or include a PC that the network device 110 is connected to and/or otherwise in communication with (e.g., via the network 140). According to some embodiments, however, the network device 110 may be interfaced with utilizing the input device 150.

For example, the user may enter input into the input device 150 to control the network device 110. The input (e.g., commands and/or other information) may then, for example, generate one or more associated outputs from the input device 150 that are directed to the client device 130. The client device 130 may, according to some embodiments, forward the output to the host device 120. In some embodiments, the client device 130 may emulate the input device 150 on the host device 120. In other words, the client device 130 may send the output to the host device 120 so that the output appears (e.g., to the host device 120) to have been received from a locally-connected (e.g., local to the host device 120) USB device.

In some embodiments, the output from the input device 150 may be generated, transmitted, and/or otherwise associated with one or more particular data formats, protocols, and/or specifications. The output may, for example, be configured in accordance with the USB 2.0 standard. In some embodiments, the output may be converted to and/or emulated as USB output that is provided to the host device 120. The client device 130 may, for example, utilize the output to create and/or define one or more USB packets that are sent to the host device 120 via IP (e.g., over the network 140).

The host device 120 may, according to some embodiments, send the output to the network device 110. In some embodiments, information associated with the network device 110 may also or alternatively be provided to the host device 120. The host device 120 may, for example receive and/or retrieve information from the network device 110. In some embodiments, the information may be received and/or retrieved at least in part in response to the output received from the input device 150 (e.g., via the client device 130). According to some embodiments, the network device information may be received, solicited, and/or retrieved based upon the occurrence of an event and/or the satisfying of a condition. The network device information may then, for example, be sent to the client device 130. The client device 130 may process the information and/or may forward or send the information to the display device 160. The display device 160 may, according to some embodiments, be or include any type or configuration of display device and/or other output device that is or becomes known or practicable. In some embodiments, the display device 160 may be utilized by (e.g., viewed by, in proximity to, and/or otherwise associated with) the user of the input device 150. In such a manner, for example, the user may interact with and/or control the network device 110 by utilizing the client device 130 and the host device 120 to exchange information utilizing USB-bridging and/or remote USB services.

The user operating the input device 150 may, for example, be within proximity to the display device 160, and the client device 130 may provide information via the display device 160 to the user. According to some embodiments, other output devices may be utilized in the system 100 in addition to or in place of the display device 160. In some embodiments, the display device 160 and the input device 150 may be or include the same device. The input device 150 may be or include a keypad and a display, for example, and/or the display device 160 may be a touch-screen display capable of receiving input.

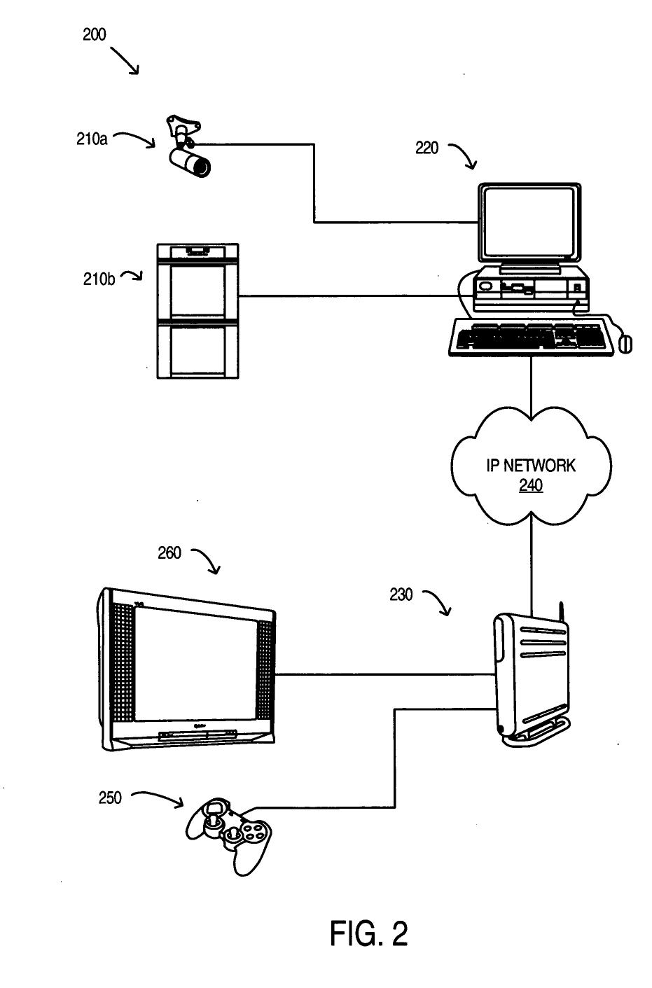

Referring in more detail to FIG. 2, a block diagram of a system 200 according to some embodiments is shown. The system 200 may include, according to some embodiments, one or more network devices 210a-b, a host device 220, a client device 230, an IP network 240, an input device 250, and/or a display device 260. The network devices 210a-b, the host device 220, the client device 230, the input device 250, and/or the display device 260 may, according to some embodiments, be coupled, connected, and/or otherwise in communication (e.g., via a network such as the IP network 240). In some embodiments, the components 210, 220, 230, 240, 250, 260 of the system 200 may be similar in configuration and/or functionality to the similarly-named components described in conjunction with FIG. 1. In some embodiments, fewer or more components than are shown in FIG. 2 may be included in the system 200.

According to some embodiments, the input device 250 may be or include a game pad, as shown in FIG. 2. A user may, for example, utilize the game pad 250 to play a computer or video game on the display device 260, which may, for example, be a TV. In some embodiments, either or both of the TV 260 and the game pad 250 may be coupled to and/or otherwise in communication with the client device 230. The client device 230 may, for example, be a Digital Media Adaptor (DMA) device configured to communicate in accordance with the “Information Technology—Telecommunications And Information Exchange Between Systems—Local And Metropolitan Area Networks” standard 802.11b-1999® published by the IEEE. In some embodiments, the client device 230 may be or include a DMA device such as a Linksys® Wireless-B™ Media Adapter. The DMA device 230 may, for example, be utilized to connect either or both of the game pad 250 and the TV 260 to the IP network 240 (e.g., the user's home network).

In some embodiments, the DMA device 230 may facilitate the coupling, communication, and/or other exchange of information and/or interface between the game pad 250 and/or the TV 260 and the host device 220. The host device 220 may, for example, be a PC connected to the IP network 240. The PC 220 may, according to some embodiments, be coupled to and/or otherwise in communication with various device such as the network devices 210a-b. As shown in FIG. 2, the network device 210a-b may be devices such as cameras (e.g., security cameras) and/or appliances (e.g., “smart” appliances). The network devices 210a-b may, for example, be located within the user's home and/or may be coupled to the IP network 240 (e.g., directly and/or via the PC 220).

As an example of some embodiments, the user (who may be associated with any or all of the devices 210a-b, 220, 230, 250, 260 and/or the network 240) may utilize the game pad 250 to play a game displayed on the TV 260. In some embodiments, the game may be a PC game played utilizing remote USB-bridging services provided by the PC 220 (e.g., via the DMA device 230). The user may, according to some embodiments, desire to check the status of and/or control one or more of the network devices 210a-b. In the case that the first network device 210a is a security camera near the user's front door (or in a baby's room, etc.), the user may, for example, desire to view the video feed from the camera 210a. In some embodiments, instead of being required to go to the PC 220 to interact with software that controls and/or provides access to the video feed (as would be required in typical systems), the user may simply utilize the game pad 250 to control and/or interface with the camera 210a.

For example, the user may provide input to the game pad 250 (e.g., joystick movements, button presses, and/or switch toggles) and the game pad 250 may utilize the input to generate one or more outputs. The outputs may be sent to the DMA device 230, which may, for example, process the outputs to create one or more USB packets. In some embodiments, the DMA device may utilize key mapping information to map and/or otherwise associate various outputs from the game pad 250 with various commands and/or actions. The mapping information may, for example, associate an output from the game pad 250 with the camera 210a and/or with an action, command, and/or other parameter associated with the camera 210a.

In the case that the DMA device 230 determines that mapping information exists and/or is already defined for the game pad 250, the DMA device 230 may automatically, according to some embodiments, utilize the mapping information to process the received outputs. In the case that no mapping information is defined for the game pad 250, the DMA device 230 may, for example, prompt the user via the TV 260 to define, enter, create, and/or select the mapping information. In some embodiments, the DMA device 230 may utilize the mapping information to create one or more USB packets associated with the output. The DMA device 230 may then, according to some embodiments, provide and/or send the USB packets to the PC 220 via the IP network 240. In some embodiments, the information (e.g., the USB packets over IP) sent to the PC 220 may be associated with emulating the game pad 250 as an input device on the PC 250.

The USB packets may be received by the PC 220, for example, as if they had originated from a USB device connected directly to the PC 220. In some embodiments, the PC 220 may utilize the received information to control and/or otherwise interact with the camera 210a. The PC 220 may, for example, pass the information and/or an indication thereof to a security system (not shown) and/or software that is capable of controlling and/or interfacing with the camera 210a. According to some embodiments, the PC 220 may send a signal directly to the camera 210a (e.g., such as in the case the camera 210a is a USB camera). In the case that the user desired to check the status of the camera 210a and/or view the video feed from the camera 210a, the PC 220 may solicit and/or otherwise acquire information from the camera 210a. The video feed from the camera 210a may, for example, be directed to the PC 220 (e.g., in response to the information received from the game pad 250 and/or the DMA device 230).

The PC 220 may then, for example, provide the video feed to the DMA device 230. The video feed may, according to some embodiments, be compressed, encoded, and/or encrypted prior to and/or during transmission to the DMA device 230 over the IP network 240. The DMA device 230 may decode, decompress, and/or decrypt the video feed and/or may provide the video feed to the TV 260 (e.g., for display to the user). According to some embodiments, any other activity associated with the game pad 250 and/or the TV 260 may be suspended and/or augmented to provide the video feed to the user. In the case that the user is playing a remote USB game hosted by the PC 220, for example, the PC 220 may pause and/or suspend the game while interfacing with the camera 210a and/or while providing the video feed to the user. In some embodiments, the user may choose whether or not any activity is desired to be paused or suspended. The video feed and/or camera status information may, for example, be displayed to the user via the TV 260 utilizing only a portion of the screen (e.g., Picture-In-Picture (PIP) and/or closed-captioning) and/or otherwise without requiring pausing or suspension of the user's activity.

In such a manner, for example, the user may control and/or interface with the camera 210a utilizing remote USB-bridging over the IP network 240. The user may, for example, view video feed from the camera 210a on the TV 260 and/or control the movement of the camera 210a utilizing a joystick and/or directional pad of the game pad 250. Similarly, the user may control and/or interface with other network devices 210. The second network device 210b may, for example, be a “smart” double-oven that the user desires to interface with, without having to go into the kitchen and/or without having to suspend the user's current activity (e.g., playing a video game).

The user may, for example, desire to set the temperature of the oven 210b, check the timer (e.g., to see how much time is left before dinner is ready), and/or otherwise control or interface with the oven 210b. In some embodiments, the DMA device 230 may replicate and/or render an oven control panel on the screen of the TV 260. The user may then, for example, utilize the game pad 250 (and/or a portion thereof) to interface with the oven 210b.

According to some embodiments, the user may continue utilizing the game pad 250 to play the video game while interfacing with the oven 210b. The user may also or alternatively pause and/or suspend any or all other activity during the interface with the oven 210b.

According to some embodiments, the network devices 210a-b, the game pad 250, the TV 260, and/or the DMA device 230 may be identified, detected, and/or discovered. The PC 220 (and/or any of the other devices 210a-b, 230, 250, 260) may, for example, include “Plug-and-Play” functionality that allows the PC 220 (and/or the DMA device 230) to determine when a device is connected to the network 240 (and/or to the PC 220 or DMA device 230 directly). In the case that the DMA device 230 emulates the game pad 250 on the PC 220, for example, the PC 220 may automatically detect, identify, and/or otherwise manage the newly connected and/or activated device. The PC 220 may, according to some embodiments, automatically detect and/or configure any or all connected and/or activated network devices 210a-b. The DMA device 230 may also or alternatively automatically detect and/or configure the game pad 250 and/or the TV 260. Device discovery and/or configuration may, according to some embodiments, be performed by Bluetooth® and/or in accordance with Universal Plug and Play (UPnP) networking architecture.

In some embodiments, more DMA devices 230 than are shown in FIG. 2 may be utilized in the system 200. In the case that the camera 210a and/or the oven 210b is remotely located from and/or otherwise not capable (or easily capable) of direct connection to the PC 220, for example, another DMA device (not shown) may be coupled to the network devices 210a-b to facilitate communication with the PC 220. According to some embodiments, the network devices 210a-b may be emulated as input devices on the PC 220. The PC 220 may, for example, provide USB-bridging services for both the controlling (e.g., the game pad 250) and the controlled (e.g., the camera 210a and/or the oven 210b) devices.

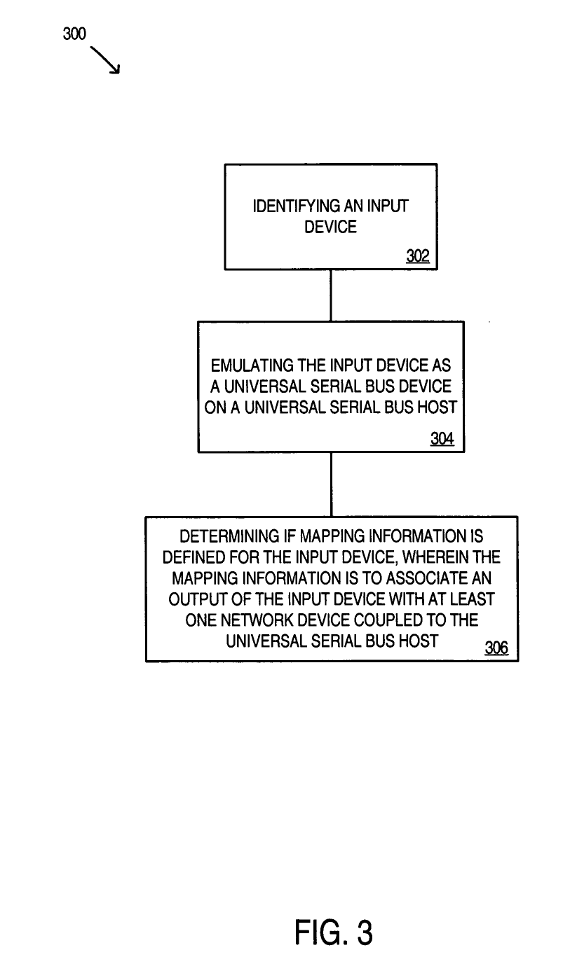

Referring now to FIG. 3, a method 300 according to some embodiments is shown. In some embodiments, the method 300 may be conducted by and/or by utilizing the systems 100, 200 and/or may be otherwise associated with the systems 100, 200 and/or any of the system components described in conjunction with any of FIG. 1 and/or FIG. 2. The method 300 may, for example, be performed by and/or otherwise associated with the client device 130, 230 described herein. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 300 may begin at 302 by identifying an input device. An input device such as the input devices 150, 250 described in conjunction with FIG. 1 and/or FIG. 2 may, for example, be automatically detected. The detection may, according to some embodiments, occur upon connection and/or activation of the input device. A client device (such as a client device 130, 230) may, for example, perform a search for an input device that may be coupled to the client device (and/or resident on a shared network). According to some embodiments, Bluetooth® technology may be used to actively discover a connected and/or nearby input device.

In some embodiments, the input device may be otherwise identified, determined, and/or located. The input device may, for example, transmit a signal to assist a client device in locating and/or identifying the input device. In some embodiments, the client device may store a list of available input devices and/or may otherwise lookup an address, identifier, and/or locator associated with an input device. In some embodiments, one or more available input devices may be selected, identified, and/or otherwise chosen. According to some embodiments, the identified input device may be an input device that is to be used to control and/or interface with a remotely located network device.

According to some embodiments, the method 300 may continue by emulating the input device as a universal serial bus device on a universal serial bus host, at 304. The USB host may, for example, be a PC with USB functionality that is capable of providing remote USB-bridging services. In other words, a potentially non-USB input device and/or a potentially remote input device (e.g., remote from the USB host) may be loaded, installed, and/or otherwise interfaced with the USB host (e.g., the host device 120, 220) as a local USB device (e.g., local to the host). In some embodiments, the USB host may load a driver and/or otherwise install, initiate, and/or configure the emulated USB device. As an example, the input device may be a game pad coupled to a DMA device that may be interfaced with the USB host as a local USB game pad.

According to some embodiments, a software and/or other application or module on the client device, such as a USB control transfer application, may conduct and/or manage the device emulation. In some embodiments, the emulation may also or alternatively be conducted by and/or at the USB host. In some embodiments, such as in the case that the input device in not USB-capable, the client device may convert and/or otherwise process output received from the input device to provide the output as USB packets over an IP network to the USB host. In some embodiments, the client device may convert the output into one or more USB packets and transmit the packets over a network (e.g., the network 140, 240) to the USB host.

An application resident on the client device may, for example, structure and/or package game pad output as one or more USB packets. The USB packets may, according to some embodiments, be sent to the USB host over an IP network (e.g., the IP network 240). The USB packets may be received by the USB host, for example, as if they had originated from a local USB device (e.g., the emulated USB device). In some embodiments, an input device that lacks USB functionality and/or is remotely located from the USB host may accordingly utilize the USB-bridging services of the USB host to interface with one or more network devices in communication with the USB host. In some embodiments, the USB host may be automatically identified and/or determined (e.g., in accordance with UPnP and/or Bluetooth®).

The method 300 may continue at 306 by determining if mapping information is defined for the input device, wherein the mapping information is to associate an output of the input device with at least one network device coupled to the USB host. In the case that the input device has been previously coupled to a DMA device, for example, the DMA device may store a record of the settings previously utilized by the input device. In some embodiments, the DMA device may store default settings and/or mappings for a class and/or type of input device. The default and/or previous settings may, for example, be automatically loaded and/or identified upon identification, detection, and/or configuration of the input device.

The mapping information may include, according to some embodiments, information associating one or more outputs of the input device to on or more commands, requests, and/or other signals to be delivered to a particular network device. In the case that no mapping information is defined for the input device, for example, any or all available network devices may be determined and/or identified. The DMA device may, in some embodiments, query the USB host, for example, to determine what network devices are available. The identified network devices may then be presented (e.g., via a display device) to a user associated with the input device. The user may, according to some embodiments, utilize the information to associate one or more of the available network devices with various keys and/or other input features of the input device.

In some embodiments, in the case that the mapping information is determined to be defined for the identified input device, the mapping information may be provided (e.g., via a display device) to the user. The user may, for example, be given the opportunity to examine, approve, and/or edit the mapping information. In some embodiments, the user may utilize the input device to configure and/or reconfigure the input device (e.g., by editing and/or defining the mapping information). Once the mapping information is defined (and/or determined to be defined), the input device may be utilized to interface with any associated network device.

The user may, for example, utilize the input device to interact with on-screen menus (e.g., on a TV) provided by the DMA device. The on-screen menus may, according to some embodiments, allow the user to check the status of, control, and/or otherwise interface with available and/or mapped network devices. In some embodiments, the input device may also or alternatively be utilized to perform other functions. The user may, for example, utilize the input device to play a game (e.g., displayed on the display device and/or TV). According to some embodiments, the DMA device may alert the user when a mapped and/or available network device requires attention and/or when an event associated with a network device occurs. In some embodiments, the events and/or notifications may be defined, configured, and/or customized by the user (e.g., utilizing the input device).

Once the oven 210b from FIG. 2 is mapped to the input device (e.g., the game pad 250) the user may begin and/or continue other activities such as watching TV or playing a video game, for example. During the user's other activities, if the oven 210b requires attention (e.g., the timer reaches zero), the USB host may send an indication of the event to the DMA device coupled to the input device. The USB host may, according to some embodiments, monitor any connected and/or mapped network devices to determine if and/or when various events occur (e.g., event triggers). The DMA device, upon receiving the indication, may process and/or send the indication to the display device (and/or other device) being utilized by the user. A message indicating that dinner is ready, for example, may be scrolled across the display device while the user plays a video game. In such a manner, for example, the user may be notified of any important events that occur in relation to network devices (e.g., throughout the user's home network), without requiring interruption of the user's other activities (e.g., game playing and/or TV watching).

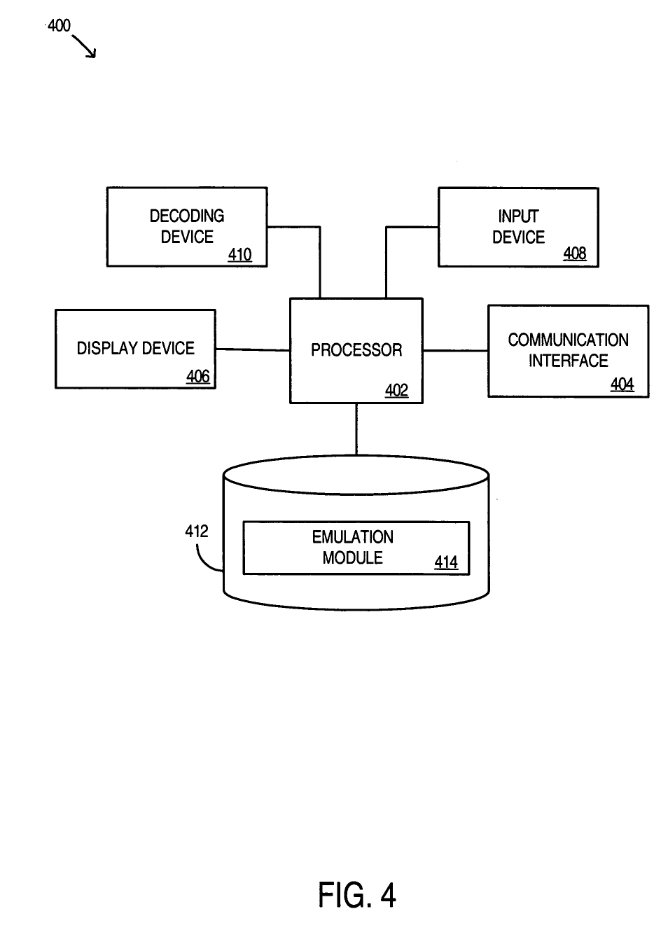

Turning now to FIG. 4, a block diagram of a system 400 according to some embodiments is shown. The system 400 may, for example, be utilized to implement and/or perform the method 300 described herein and/or may be associated with the systems 100, 200 described in conjunction with any of FIG. 1 and/or FIG. 2. In some embodiments, fewer or more components than are shown in FIG. 4 may be included in the system 400. According to some embodiments, different types, layouts, quantities, and configurations of systems may be used.

In some embodiments, the system 400 may be or include a DMA and/or other client device. According to some embodiments, the system 400 may be a client device such as the client devices 130, 230 described herein. In some embodiments, the system 400 may be a wireless DMA device utilized to interface with a host device that provides USB-bridging services to allow an input device (such as a game pad) to interface with one or more network devices coupled to the USB host. The system 400 may include, for example, one or more processors 402, which may be any type or configuration of processor, microprocessor, and/or micro-engine that is or becomes known or available. In some embodiments, the system 400 may also or alternatively include one or more communication interfaces 404, a display device 406, an input device 408, a decoding device 410, and/or a memory device 412, all and/or any of which may be in communication with the processor 402. The memory device 416 may store, for example, an emulation module 414.

The communication interface 404 may be or include any type and/or configuration of communication device that is or becomes known or available. In some embodiments, the communication device 404 may allow the system 400 (and/or the processor 402) to communicate with, for example, one or more input devices (e.g., input devices 150, 250) and/or one or more host devices (e.g., host devices 120, 220). According to some embodiments, the communication interface 404 may be or include a Network Interface Card (NIC) such as an Intel® PRO/1000 MT Desktop Adaptor that operates in accordance with the Fast Ethernet LAN transmission standard 802.3-2002® published by the IEEE, or an Intel® PRO/Wireless 2225BG Network Connection that operates in accordance with the Wireless LAN transmission standard 802.11b/g-1999/2003® published by the IEEE.

The display device 406 may be or include any type of display device that is or becomes known or practicable, including, but not limited to, a Cathode Ray Tube (CRT) display device, a Liquid Crystal Display (LCD) device, and/or a Light-Emitting Diode (LED) display device. In some embodiments, the display device 406 may not be included in the system 400. Output from the system 400 may be provided, for example, via one or more other devices, such as the display device 160, 260 described herein. In some embodiments, the system 400 may provide a Graphical User Interface (GUI), for example, to another device such as the TV 260 to display the GUI to a user. According to some embodiments, the display device 406 may comprise one or more lights or diodes that provide status and/or connectivity information based upon their illumination (and/or lack thereof).

The input device 408 may be or include one or more conventional devices such as a keyboard, a mouse, a remote control, a trackball, etc. The input device 408 may be utilized, for example, by an operator and/or system user to interface with the emulation module 414 running on the system 400 (e.g., executed by the processor 402) and/or to facilitate the interface between the system 400 and one or more host devices and/or input devices. In some embodiments, the input device 408 may be or include an Infrared Radiation (IR) interface to receive signals, commands, and/or other input from an IR remote control device (not shown). In some embodiments, other forms of remote control (e.g., Radio Frequency (RF) and/or carrier-line signaling) may also or alternatively be utilized. According to some embodiments, the input device 408 may also or alternatively be or include a game pad interface to facilitate communication with one or more gaming input devices.

In some embodiments, the system 400 may include the decoding device 410. The decoding device 410 may, for example, decode information received from a USB host. According to some embodiments, network device information (e.g., status, identifier, audio, video, and/or other information) may be encoded and/or compressed by a USB host and sent to the client device. The network device information may then, for example, be decoded and/or decompressed by the decoding device 410. In some embodiments, the decoding device 410 may be capable of decoding information in accordance with the Moving Pictures Expert Group (MPEG) Release Two (MPEG-2) 13818 standard (1994) published by the International Standards Organization (ISO) and the International Electrotechnical Commission (IEC), and/or in accordance with the MPEG-4 14496 (1999/2002) standard published by ISO/IEC. Other forms, standards, and/or types of decoding (and/or encoding) may be performed by the decoding device 410 without deviating from some embodiments.

The memory device 412 may be or include, according to some embodiments, one or more magnetic storage devices, such as hard disks, one or more optical storage devices, and/or solid state storage. The memory device 412 may store, for example, the emulation module 414. The emulation module 414 may be or include, for example, a USB control transfer module and/or application that is capable of emulating and/or facilitating the emulation of a USB device. The emulation module 414 may, according to some embodiments, emulate a USB input device (e.g., at 304) by providing information received from one or more input devices as USB packets to a host device over an IP network. The USB packets (and/or other form and/or configuration of output information provided by the emulation module 414) may, for example, be utilized by the host device as if they were received from a locally connected USB input device (e.g., local to the host).

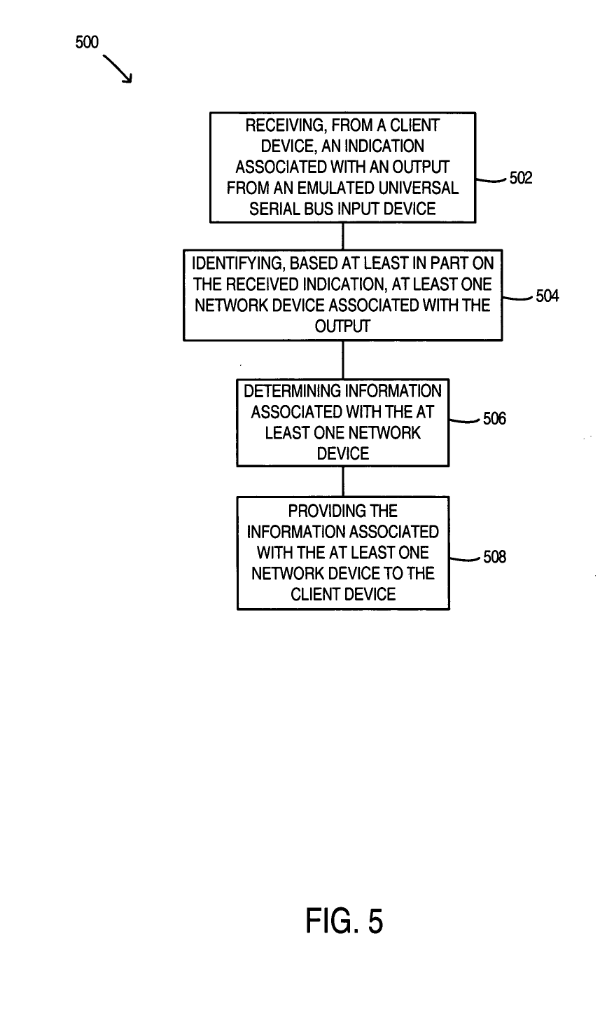

Referring now to FIG. 5, a method 500 according to some embodiments is shown. In some embodiments, the method 500 may be conducted by and/or by utilizing the systems 100, 200, 400 and/or may be otherwise associated with the systems 100, 200, 400 and/or any of the system components described in conjunction with any of FIG. 1, FIG. 2, and/or FIG. 4. The method 500 may, for example, be performed by and/or otherwise associated with the host device 120, 220 described herein.

In some embodiments, the method 500 may begin at 502 by receiving, from a client device, an indication associated with an output from an emulated USB input device. A USB host device (e.g., the host device 120, 220) such as a PC may, for example, receive information from a DMA device. The DMA device may, according to some embodiments, be or include a client device such as one or more of the client devices 130, 230 described herein. In some embodiments, the indication associated with the output may include a USB packet sent via an IP network from a client device. The indication associated with the output may, for example, be information indicative of an emulated USB output associated with an input device coupled to the client device. The USB packet and/or USB output may, according to some embodiments, represent and/or include information associated with input entered into the input device and provided to the client device. The indication associated with the output may, for example, comprise information associated with controlling and/or otherwise interfacing with a network device coupled to the USB host.

According to some embodiments, a driver may be loaded to facilitate the interface between a host device providing remote USB-bridging services and a client device that emulates an input device on the host device. The driver may, for example, be a software driver configured to manage the exchange of information between the host device and the emulated universal serial bus device (and/or the client device). In some embodiments, such as in the case that the input device is a USB-capable device, the driver may be or include the same driver that would be loaded if the user device were directly connected and/or coupled to the host device. According to some embodiments, other drivers and/or code may be loaded and/or executed to enable the host device to interpret, utilize, and/or otherwise process the indication associated with the output received from the client device.

The method 500 may continue, for example, by identifying, based at least in part on the received indication, at least one network device associated with the output, at 504. In some embodiments, a plurality of network devices may be coupled to and/or otherwise associated with the USB host. In the case that the USB host is a PC operating on a user's home network, for example, any number of security devices, appliances, electronics, and/or other computational devices (e.g., a PDA and/or a laptop) may be in communication with the PC. Some network devices may be connected directly to the PC via one or more cables such as a USB cable and/or a Category 5e (CAT 5e) cable. Some network devices may be connected to the PC via a DMA and/or other device or adaptor.

In some embodiments, the indication received at 502 may include information identifying a particular network device. The information may include, for example, an identifier and/or code associated with a network device coupled to the PC. According to some embodiments, the PC may otherwise determine a network device that is associated with the output from the input device. The PC may, for example, store and/or otherwise have access to a matrix, database, and/or file that associates the output (and/or the indication thereof) with one or more network devices. The PC may, for example, store and/or have access to mapping information associated with the input device. In some embodiments, the network device may be automatically identified, detected, and/or determined utilizing Bluetooth® and/or UPNP technology.

According to some embodiments, the method 500 may continue at 506 by determining information associated with the at least one network device. The output received from the input device (e.g., via the client device) may, for example, indicate a desired action, command, and/or other interaction with the identified network device. In the case that the user of the input device desires the status of the network device, for example, the status of the network device may be determined by the PC. In some embodiments, the network device information may be captured and/or otherwise acquired. In some embodiments, the information requested of the network device may include video feed (e.g., from the camera 210a) and/or other information (e.g., temperature of the oven 210b). The host PC may, for example, include audio, video, and/or other capture devices (e.g., hardware and/or software devices) configured to capture information from the network device.

In some embodiments, the host PC may monitor the network device to determine when information is produced and/or otherwise becomes available. According to some embodiments, the host PC may monitor the network device to determine if one or more events have occurred and/or conditions have been met. The PC may store and/or have access to, for example, information defining one or more events or conditions associated with the network device. The PC may monitor the network device to determine if an event or condition has been triggered. In some embodiments, information associated with the network device and/or the occurrence of an event or condition may be automatically provided to the client device (e.g., to be provided to the user of the input device and/or to another user). The indication received at 502 may, for example, be an indication defining and/or identifying an event, condition, and/or other trigger.

The method 500 may continue at 508, according to some embodiments, by providing the information associated with the at least one network device to the client device. In other words, according to some embodiments, any information requested via the input device may be provided back to the requestor (e.g., the user of the input device). In the case that the network device provides audio and/or video information, for example, the host PC may capture the audio and/or video information to create and/or define one or more USB packets. The host PC may, for example, send the USB packets to the client device (e.g., over IP), which may then, according to some embodiments, forward the network device information to a display and/or other output device. The display and/or other output device may, for example, be associated with a user utilizing the input device. In some embodiments, the host PC may encode, compress, encrypt, and/or otherwise process the network device information prior to sending the network device information to the client device. The network device information may be encoded, for example, in accordance with the MPEG-2 or MPEG-4 standards. In some embodiments, other formats and/or standards may be used. According to some embodiments, any audio portions of the network device information may be encoded and/or sent separately (e.g., via separate cables or wires) from any video and/or other portions of the network device information.

According to some embodiments, the network device and/or the client device may be identified and/or discovered. The host PC (and/or the client device and/or the network device) may, for example, include “Plug-and-Play” functionality that allows the host PC to determine when a device is connected to the network (and/or to the host PC directly). In the case that the client device emulates an input device on the host PC, for example, the host PC may automatically detect, identify, and/or otherwise manage the newly connected and/or activated device. Device discovery and/or configuration may, according to some embodiments, be performed by Bluetooth® and/or in accordance with Universal Plug and Play (UPnP) networking architecture.

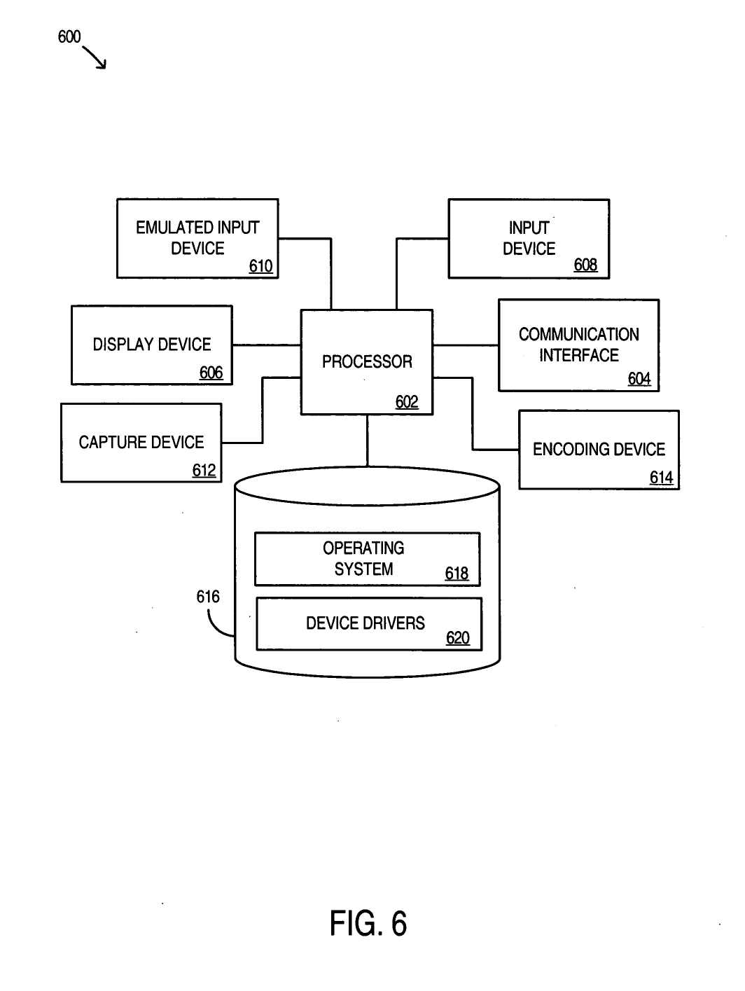

Turning now to FIG. 6, a block diagram of a system 600 according to some embodiments is shown. The system 600 may, for example, be utilized to implement and/or perform the method 500 described herein and/or may be associated with the systems 100, 200, 400 described in conjunction with any of FIG. 1, FIG. 2, and/or FIG. 4. In some embodiments, fewer or more components than are shown in FIG. 6 may be included in the system 600. According to some embodiments, different types, layouts, quantities, and configurations of systems may be used.

In some embodiments, the system 600 may be or include a computer such as a PC, a computer server, and/or a notebook computer. According to some embodiments, the system 600 may be a host computer such as the host device 120, 220 described herein. In some embodiments, the system 600 may be a computer utilized to facilitate the interface between an input device and one or more network devices. The system 600 may include, for example, one or more processors 602, which may be any type or configuration of processor, microprocessor, and/or micro-engine that is or becomes known or available. In some embodiments, the system 600 may also or alternatively include one or more communication interfaces 604, a display device 606, an input device 608, an emulated input device 610, a capture device 612, an encoding device 614, and/or a memory device 616, all and/or any of which may be in communication with the processor 602. The memory device 616 may store, for example, an operating system 618 and/or device drivers 620.

The communication interface 604, the display device 606, and/or the input device 608 may be or include any types and/or configurations of devices that are or become known or available. In some embodiments, the components 604, 606, 608 of the system 600 may be similar in configuration and/or functionality to the similarly-named components described in conjunction with FIG. 4 herein. The input device 608 may be or include one or more conventional devices such as a keyboard, a mouse, a trackball, etc. The input device 608 may be utilized, for example, by an operator and/or system user to interface with the operating system 618 running on the system 600 (e.g., executed by the processor 602) and/or to facilitate the interface between an input device and a network device (and/or one or more client devices).

According to some embodiments, the system 600 may include an emulated input device 610. The emulated input device 610 may, for example, be an input device and/or a representation of an input device. In some embodiments, the emulated input device 610 may be an input device that is treated like and/or viewed as a USB device and/or component by the system 600. The emulated input device 610 may, for example, be an emulated USB game pad and/or related device. In some embodiments, the emulated input device 610 may be or include a driver (such as one of the device drivers 620) and/or other component and/or device that facilitates the interface between the system 600 and an input device and/or a client device. According to some embodiments, the emulated input device 610 may be an input device associated with a client device that is emulated by the client device on the system 600.

In some embodiments, the system 600 may also or alternatively include the capture device 612 and/or the encoding device 614. The capture device 612 may, for example, be utilized to capture information from a network device, a client device, and/or the emulated input device 610. In the case that the system 600 receives and/or transmits audio and/or video information and/or other network device information, for example, the capture device 612 may include a video capture device and/or an audio capture device. The capture device 612 may, according to some embodiments, record, store, and/or otherwise process output generated by one or more network devices. The capture device 612 may, for example, be utilized to capture audio and/or video information to provide to a client device associated with the emulated input device 610.

According to some embodiments, audio, video, and/or other information (e.g., captured from a network device) may be encoded and/or compressed prior to providing the output to a client device and/or to the emulated input device 610. The encoding device 614 may, for example, encode and/or compress the network device information captured by the capture device 612. The encoded and/or compressed information may then, for example, be transmitted to a client device and/or to the emulated input device 610 to facilitate the control and/or interface of a network device via the input device emulated in the system 600.

The memory device 616 may be or include, according to some embodiments, one or more magnetic storage devices, such as hard disks, one or more optical storage devices, and/or solid state storage. The memory device 616 may store, for example, the operating system 618, the device drivers 620 (e.g., to interface with the input device 608, the display device 606, and/or the emulated input device 610). The device drivers 620 may, according to some embodiments, include one or more Windows® Human Interface Device (HID) drivers to provide an interface between a bus driver (such as a USB driver) and an input device (e.g., the emulated input device 610). In some embodiments, the device drivers 620 may also or alternatively include one or more other drivers and/or driver types such as one or more USB drivers.

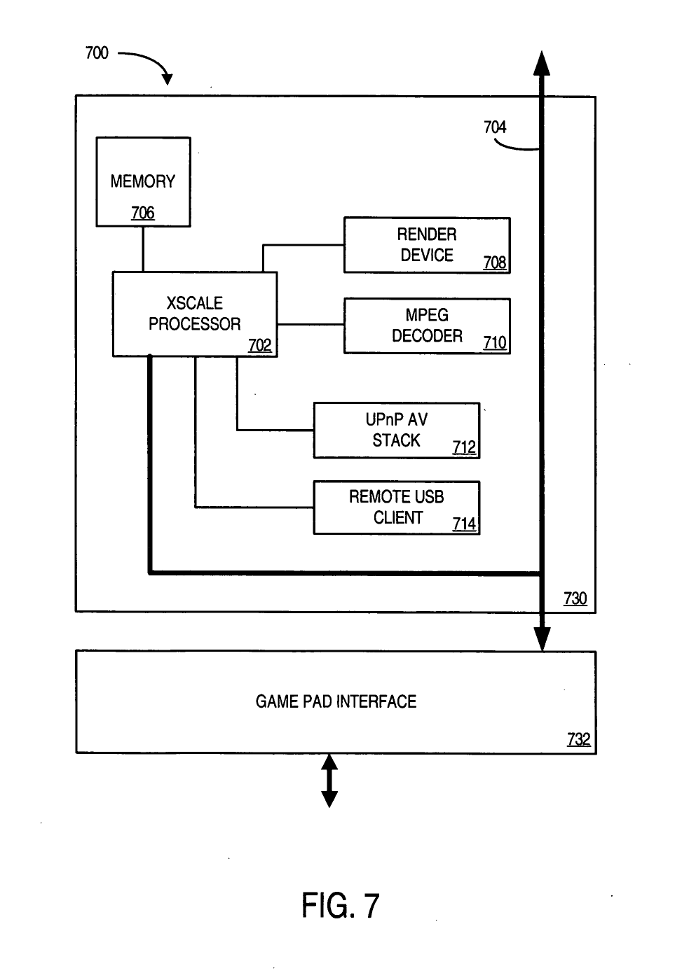

Turning now to FIG. 7, a block diagram of a system 700 according to some embodiments is shown. The system 700 may, for example, be associated with the method 300 described above and/or may be similar in configuration and/or functionality to the systems 100, 200, 400, 600 described in conjunction with any of FIG. 1, FIG. 2, FIG. 4, and/or FIG. 6. In some embodiments, the system 700 may be or include a DMA device such as the client devices 130, 230 described herein. Fewer or more components that are shown in FIG. 7 may, according to some embodiments, be included in the system 700. In some embodiments, the components 702, 704, 706, 708, 710, 712, 714, 730, 732 of the system 700 may be similar in configuration and/or functionality to the similarly-named components described in conjunction with any of FIG. 1, FIG. 2, FIG. 4, and/or FIG. 6 herein.

The system 700 may, according to some embodiments, include an XScale® Processor 702 (such as an Intel® PXA270 XScale® processor), a network interface 704, a memory 706, a render device 708, an MPEG decoder 710, an UPnp Audio Visual (AV) stack 712, and/or a remote USB client 714. In some embodiments, the system 700 may also or alternatively comprise a DMA device 730 and/or a game pad interface 732. The DMA device 730, as shown in FIG. 7 for example, may comprise one or more of the components 702, 704, 706, 708, 710, 712, 714 of the system 700. According to some embodiments, the game pad interface 732 may be either separate from or integrated with the DMA device 730.

The network interface 704 may comprise any number, type, and/or configuration of network interface devices and/or components that are or become known. In some embodiments, the network interface 704 may include, for example, a NIC configured for communication over an IP network and/or a NIC configured for wireless 802.11a/b/g®, Bluetooth®, and/or RF communications. The memory 706 may comprise, for example, any type of memory for storing data, such as Single Data Rate Random Access Memory (SDR-RAM), Double Data Rate Random Access Memory (DDR-RAM), and/or Programmable Read Only Memory (PROM).

In some embodiments, the DMA device 730 may utilize the network interface 704 to communicate with one or more host devices, input device, and/or display devices over one or more networks. The system 700 may, according to some embodiments, communicate with a host device to implement embodiments as described herein. The remote USB client 714 may, for example, emulate an input device as a USB device local to a remote USB host computer. Information from a host device may be received via the network interface 804, for example. In some embodiments, the information may comprise network device information associated with a network device coupled to the host device. The DMA device 730 may also or alternatively receive output from an input device via the game pad interface 732. The information may include, for example, output associated with controlling and/or interfacing with a network device coupled to a remote USB host PC. According to some embodiments, the DMA device 730 may covert, process, and/or otherwise utilize the output to create one or more USB packets.

In some embodiments, the USB packets may be transmitted (e.g., via the network interface 704) to a host and/or a remote host over an IP network (and/or another type of network). The host may utilize the USB packets as if they were received from a locally-connected USB device. The host may, for example, supply the information from the emulated USB device to a particular network device (such as the camera 210a or the oven 210b). In some embodiments, the network device may respond by providing information to the remote USB host. The remote USB host may then, for example, forward the response information back to the system 700 (e.g., via the network interface 704). The MPEG decoder 710 may, for example, decode and/or decompress any received information and provide the information to the render device 708. According to some embodiments, the render device 708 may utilize the information received from the host device to render audio, video, and/or other information associated with the network device on a display device (e.g., on the TV 260) or other output device associated with a user.

According to some embodiments, the system 700 and/or the DMA device 730 may include the UPnP AV stack 712. The UPnP AV stack 712 may, for example, be or include software, hardware, and/or firmware that allows and/or facilitates device discovery. The UPnP AV stack 712 may, for example, allow the system 700 and/or the DMA device 730 to detect and/or identify any or all devices capable of communicating via the network interface 704 and/or via the game pad interface 732. For example, any network devices and/or remote USB host devices that are active and/or otherwise available on a network may be identified and/or discovered by the system 700 and/or the DMA device 730 utilizing the UPnP AV stack 712. Similarly, any game pads or other input device coupled to the DMA device 730 (e.g., via the game pad interface 732) may also or alternatively be automatically discovered, identified, and/or configured. In such a manner, for example, network and/or input devices may be connected and/or disconnected from the communication interface 704 and/or the game pad interface 732 while maintaining automated configuration and/or operation of the system 700.

In some embodiments, the system 700 and/or the DMA device 730 may receive information and/or commands via the game pad interface 732. A user utilizing a remote control device and/or game pad (e.g., the game pad 250) may, for example, interact with the DMA device 730 by sending information via the game pad interface 732. The user may, according to some embodiments, select one or more available network devices, map keys of the input device (e.g., game pad) to functions of the network device, control the network device, and/or otherwise interface with the network device utilizing the input device. In such a manner, for example, input devices on the user's home network may be utilized to control a variety of network devices connected to the user's home network and/or an associated network.

The several embodiments described herein are solely for the purpose of illustration. Those skilled in the art will note that various substitutions may be made to those embodiments described herein without departing from the spirit and scope of the present invention. Those skilled in the art will also recognize from this description that other embodiments may be practiced with modifications and alterations limited only by the claims.

What is claimed is:

1. A method, comprising:
identifying an input device;
emulating the input device as a universal serial bus device on a universal serial bus host; and
determining if mapping information is defined for the input device, wherein the mapping information is to associate an output of the input device with at least one network device coupled to the universal serial bus host.

2. The method of claim 1, further comprising:
sending, in the case that the mapping information is determined to be defined for the input device, the mapping information to a display device.

3. The method of claim 1, further comprising:
sending, in the case that the mapping information is determined not to be defined for the input device, a prompt to a display device, wherein the prompt requests that the mapping information be defined for the input device.

4. The method of claim 3, further comprising:
sending information associated with the at least one network device to the display device.

5. The method of claim 3, further comprising:
receiving a definition of the mapping information from the input device.

6. The method of claim 1, further comprising:
receiving, from the universal serial bus host, an indication that an event associated with the at least one network device has occurred.

7. The method of claim 6, further comprising:
sending the indication to a display device.

8. The method of claim 7, further comprising:
suspending an activity associated with the display device; and
causing the indication to be displayed on the display device.

9. The method of claim 1, further comprising:
receiving an output from the input device.

10. The method of claim 9, further comprising:
determining, utilizing the mapping information, an action associated with the received output.

11. The method of claim 10, further comprising:
sending an indication of the determined action to the universal serial bus host.

12. The method of claim 11, wherein the indication is sent as one or more universal serial bus packets over an internet protocol network.

13. The method of claim 11, further comprising:
receiving, at least in part in response to the indication of the determined action, information associated with the at least one network device associated with the received output.

14. The method of claim 13, wherein the information associated with the at least one network device is received as one or more universal serial bus packets over an internet protocol network.

15. The method of claim 13, further comprising:
sending the information associated with the at least one network device to a display device.

16. The method of claim 1, wherein the input device comprises a game pad.

17. The method of claim 1, further comprising:
identifying the universal serial bus host.

18. A method, comprising:
receiving, from a client device, an indication associated with an output from an emulated universal serial bus input device;
identifying, based at least in part on the received indication, at least one network device associated with the output;
determining information associated with the at least one network device; and
providing the information associated with the at least one network device to the client device.

19. The method of claim 18, further comprising:
loading a driver associated with the emulated universal serial bus input device.

20. The method of claim 18, further comprising:
encoding the information associated with the at least one network device.

21. The method of claim 18, wherein the emulated universal serial bus input device comprises a game pad.

22. The method of claim 18, wherein the information associated with the at least one network device comprises status information associated with the at least one network device.

23. The method of claim 18, wherein the information associated with the at least one network device is provided as one or more universal serial bus packets over an internet protocol network.

24. A system, comprising:
an electronic device, comprising:
an emulated universal serial bus input device;
a first network device to receive, from a client device, an indication associated with an output from the emulated universal serial bus input device, and to send, to the client device, status information associated with at least one network device; and
an encoding device to encode the information associated with the at least one network device.

25. The system of claim 24, wherein the electronic device further includes:
a second network device to receive the status information from the at least one network device.

26. The system of claim 25, wherein the first network device is an internet protocol communication device and the second network device is a universal serial bus communication device.

27. A system, comprising:
an electronic device, comprising:
a network device to receive output from an input device and to send information indicative of the output to a remote universal serial bus host device;
an emulation device to emulate the input device as a universal serial bus input device on the remote universal serial bus host device;
a decoding device to decode network device information received from the remote universal serial bus host device; and
an interface to map the output from the input device to at least one action associated with a network device coupled to the remote universal serial bus host device.

28. The system of claim 27, further comprising:
a rendering device to render the network device information on a display device associated with the input device.

29. The system of claim 27, wherein the interface is a game pad interface.
